(19) United States
(12) Patent Application Publication
(10) Pub. No.: US 2010/0301109 A1
(43) Pub. Date: Dec. 2, 2010

(54) DISPOSABLE CUP ASSEMBLY AND METHOD OF MAKING AND USING SAME

(75) Inventors: Fred Lewis, Saugus, CA (US); Armando Rand, Saugus, CA (US)

Correspondence Address: KNOBBE MARTENS OLSON & BEAR LLP, 2040 MAIN STREET, FOURTEENTH FLOOR, IRVINE, CA, 92614, US

(73) Assignee: FAMIS BRANDS, INC., Las Vegas, NV (US)

(21) Appl. No.: 12/791,605

(22) Filed: Jun. 1, 2010

Related U.S. Application Data
(60) Provisional application No. 61/243,506, filed on Sep. 17, 2009.
(60) Provisional application No. 61/183,502, filed on Jun. 2, 2009.

(51) Int. Cl. B65D 3/04; B65D 3/26; B31B 1/90; B65D 41/04; B32B 3/00

(52) U.S. Cl. 229/404; 493/108; 493/383; 220/288

(57) ABSTRACT

A disposable cup assembly having an improved coupling system for connecting a container and lid together is disclosed herein. In some embodiments, the coupling system is configured to reduce or eliminate the likelihood of the container contents from spilling when the disposable cup assembly is tipped over or used. The container, in some embodiments, can have threading along the top portion of the container that can preferably be configured to couple with a lid having a threaded flange and can create a robust connection or fitting between the lid and container.

### CROSS-REFERENCE TO RELATED APPLICATION

This application claims the benefit under 35 U.S.C. §119(e) of U.S. Provisional Patent Application No. 61/183,502, titled DISPOSABLE CUP ASSEMBLY AND METHOD OF MAKING AND USING SAME, filed Jun. 2, 2009, and Provisional Patent Application No. 61/243,506, titled DISPOSABLE CUP ASSEMBLY AND METHOD OF MAKING AND USING SAME, filed Sep. 17, 2009, the entire contents of each of which are incorporated by reference herein and made a part of this specification.

### TECHNICAL FIELD

The disclosure relates generally to the field of disposable drinking cups. More specifically, aspects of the disclosure relate to an improved coupling system between disposable containers and disposable lids, such as for paper cups, configured to reduce or eliminate the likelihood of the contents of the container from spilling, leaking or dripping.

### BACKGROUND

Disposable cups comprising containers and lids, as described herein, are typically single use products made from materials such as paper, Styrofoam, or plastic. These cups have been used for serving hot or cold beverages and can be used for various purposes. For instance, disposable cups can be used for sanitary reasons in a medical clinic or in a hospital setting. In addition, disposable cups can be used in a retail setting, such as a restaurant or café, to provide consumers with the flexibility to take a beverage to go and usually are less expensive than a multi-serve non-disposable cup.

In a retail setting, it is common for a store or consumer to place a lid on the container to help contain and insulate the contents of the cup. These lids may have an opening for liquid to pass through when a consumer drinks from the cup. However, lids with an opening can create some problems. For instance, the liquid can splash out of the opening when the cup is inadvertently jostled by the consumer. While some lids have tabs that snap into place to close the opening, these tabs fail to create a good or permanent closure, and liquid is able to spill, leak and drip even when the tab is covering the opening.

Containers and lids are typically coupled together using a snap-fit connection between the upper lip of the container and a groove along an edge of the lid. Snap-fit connections, however, present several problems. For instance, snap-fit connections have a tendency to allow liquid to collect between the lip of the container and the lid, seep or pass through imperfections or flaws in the snap-fit connection, and drip onto a consumer when the consumer is handling or taking a sip from the cup. In addition, the lid can separate from the container if the cup is squeezed by the consumer or if the cup is knocked over. There are many additional scenarios where a cup with traditional snap connections can fail and cause the liquid to spill, leak or drip from the container or lid.

### SUMMARY OF THE DISCLOSURE

There is a need for an improved container and lid connection or fitting that reduces or eliminates the likelihood of leaks, splashes and drips. The following disclosure addresses this need and includes embodiments of improved coupling systems for disposable cup assemblies, methods of manufacturing the cup assemblies, and methods of using the cup assemblies. A consumer can feel confident that the lid will not separate from the container, that there will be substantially no dripping between the container and the lid, and that there will be substantially no splashing from the lid when the cup is used. The improved cup assemblies, as disclosed herein, are configured to reduce or eliminate the likelihood of leaks, splashes and drips from the container and the lid combination. In addition, the containers and lids of the improved cup assemblies, as individual components, are superior designs to prior containers and lids.

A coupling system for disposable cup assemblies, in some embodiments, can comprise a container made from a paper material having a bottom and at least one sidewall. The at least one side wall can have an upper portion and a lower portion, wherein the upper portion can define an opening in the container for receiving a substance. At least a section of the upper portion of the container can have threading. The assembly can also have a lid adapted to cover the opening of the container. The lid can preferably have a top and at least one flange that can extend from the top and can be adapted to engage with the upper portion of the container. The flange of the lid can preferably have threads that are complementary to the threads on the container. To fasten the container and lid together, the lid can be screwed into position on the container so that the lid is integrated with the container until the lid is unscrewed from the container. This integration between the lid and the container can reduce or eliminate the likelihood of the contents of the cup from spilling, leaking or dripping.

An improved coupling system for disposable cup assemblies, in some embodiments, can comprise a lipless container that can be made from a biodegradable material capable of holding a substance hotter than about 120 degrees Fahrenheit, such as a hot beverage, and serving such beverages like hot coffee at about 180-185 degrees Fahrenheit. The lipless container can preferably have a bottom and at least one side wall, wherein the at least one side wall can have an upper portion and a lower portion. The upper portion can define an opening in the container for receiving the substance and preferably can have threading along the at least one side wall. At least a section of the upper portion of the container can have threading. In some embodiments, the at least one side wall of the container can be made of paper and the at least one side wall can have an interior surface and an exterior surface, wherein the threading can preferably be located on the exterior surface of the at least one side wall. The container can preferably be made of paper. In some embodiments, the container can have a seam along a length of the side wall and the threading can cross the seam. The threading can be a continuous helical ridge along the upper portion of the side wall of the container.

In some embodiments, the threading can be molded directly onto the container. For instance, the threading can be embossed or debossed onto the surface of a paper container. The molded threading can be made from the same paper product as the container. The molding of the threading can also include an additional support structure such as wire, additional paper, plastic or other support material. In other embodiments, the threading can be a separate component from the container such as a pre-manufactured plastic connector or other material threading that can be permanently fitted and affixed to the container during the manufacturing process. The connector can be made of a material that is different from the container such as plastic or other material that will not substantially deform when the cup assembly is in use. In some embodiments the connector can be made from the same material used to make the lid, such as plastic.

A disposable cup assembly can preferably have a lid adapted to cover the opening of the container, wherein the lid can have a top and at least one flange. The at least one flange can preferably extend from the top and can be adapted to engage with the upper portion of the container. In some embodiments, the lid can have threading along the at least one flange that is complementary to the threading of the container. The threading on the lid can be configured to allow the lid to engage with the container by twisting the lid onto the container. In some embodiments, the top of the lid can have an opening configured to dispense the substance of the container when the lid is engaged with the container and the cup assembly is in use. In some embodiments, the lid can preferably have a disk that can rotate about the top of the lid and cover the opening, wherein the disk can have an aperture configured to dispense the substance of the container when the aperture of the disk is oriented over the opening of the lid. The lid can be made of the same material as the container, and in some embodiments, the lid can be made of plastic.

A method of manufacturing cup assemblies having an improved coupling system can comprise, in some embodiments, determining a length and width for a container of the cup assembly, selecting a biodegradable material for the container suitable for holding a substance hotter than about 120 degrees Fahrenheit (e.g. about 180-185 degrees Fahrenheit), measuring and cutting a sheet of the material for the container, rolling the sheet of the material to form a side wall of the container, and applying threads along at least a portion of the side wall. In some embodiments, the biodegradable material can be paper and the threads can be applied to the side wall by molding the threads onto the paper. For instance, the threads can be embossed or debossed onto the paper. In some embodiments, the threading can be made out of plastic or a generally non-deforming material, which is affixed to the container. In other embodiments, the threading can be on a connector configured to fit or can be manufactured directly onto the upper portion of the side wall. The connector can preferably be made of a plastic material, but can be made of other materials including paper, and can be configured to be connected to the upper portion of the side wall. In some embodiments, the connector can be secured to the container by using a chemical adhesive between an inner surface of the connector and an outer surface of the container. Other manufacturing an/or chemical techniques can be used.

A method of using cup assemblies having an improved coupling system can comprise, in some embodiments, selecting a container made of a biodegradable material, preferably paper, capable of holding a substance hotter than about 120 degrees Fahrenheit (e.g. about 180-185 degrees Fahrenheit). The container can preferably have a bottom and at least one side wall, wherein the side wall can have an upper portion and a lower portion. The upper portion can define an opening for receiving the substance and can have threads along the perimeter of the opening. The method can also include positioning the container for receiving the substance, selecting a lid adapted to cover the opening of the container, positioning the lid over the opening of the container, and twisting the lid onto the container. The lid can preferably have a top and at least one flange that extend from the top and can be adapted to engage with the upper portion of the container. When the lid is twisted onto the container, the at least one flange of the lid can preferably engage with the upper portion of the container. Also, the at least one flange of the lid can preferably have threads that are complementary to the threads on the container.

### BRIEF DESCRIPTION OF THE DRAWINGS

The above-mentioned features and other features of the disclosure are further described below with reference to the drawings of specific embodiments. The specific embodiments shown in the drawings are intended to illustrate, but not limit the disclosure.

FIG. 1 is an exploded perspective top view of an embodiment of a disposable drinking cup comprising a container and lid.

FIG. 2 is a perspective top view of the disposable drinking cup of FIG. 1 with the lid coupled to the container.

FIG. 2A is a cross section view of the disposable drinking cup of FIG. 2.

FIG. 3 is a perspective top view of the container of the disposable drinking cup of FIG. 1.

FIG. 4 is a top view of the container of FIG. 3.

FIG. 5 is a side elevation view of the container of FIG. 3.

FIG. 6 is a perspective top view of the lid of the disposable drinking cup of FIG. 1.

FIG. 7 is a top view of the lid of FIG. 6.

FIG. 8 is a side elevation view of the lid of FIG. 6.

FIG. 9 is a bottom view of the lid of FIG. 6.

FIG. 10 is a perspective bottom view of the lid of FIG. 6.

FIG. 11 is an exploded perspective top view of another embodiment of a container of a disposable drinking cup, showing an alternative threading component.

FIG. 12 is an exploded perspective top view of the container of FIG. 11 showing the alternative threading component affixed to the container and a lid.

FIG. 13 is a perspective top view of the disposable drinking cup of FIG. 12 with the lid coupled to the container.

FIG. 14 is an exploded perspective top view of another embodiment of a container of a disposable drinking cup, showing an alternative threading component and another embodiment of a lid.

FIG. 15 is an exploded perspective top view of the container of FIG. 14 showing the alternative threading component affixed to the container and another embodiment of a lid.

FIG. 16 is a cross section side view of the disposable drinking cup of FIG. 15 taken at line 16-16.

### DETAILED DESCRIPTION OF SPECIFIC EMBODIMENTS

The disclosure relates to an improved coupling system for cup assemblies having a container and lid, which can be configured to substantially keep the lid from disconnecting from the container and can reduce or eliminate the likelihood of the contents of the container from inadvertently spilling. Although the improved coupling system for cup assemblies will be described with reference to the above-identified figures and in the context of a disposable drinking cup, the features of the improved coupling system can provide advantages in other applications as well, for example food containers, product packaging, fastener containers and other types of containers.

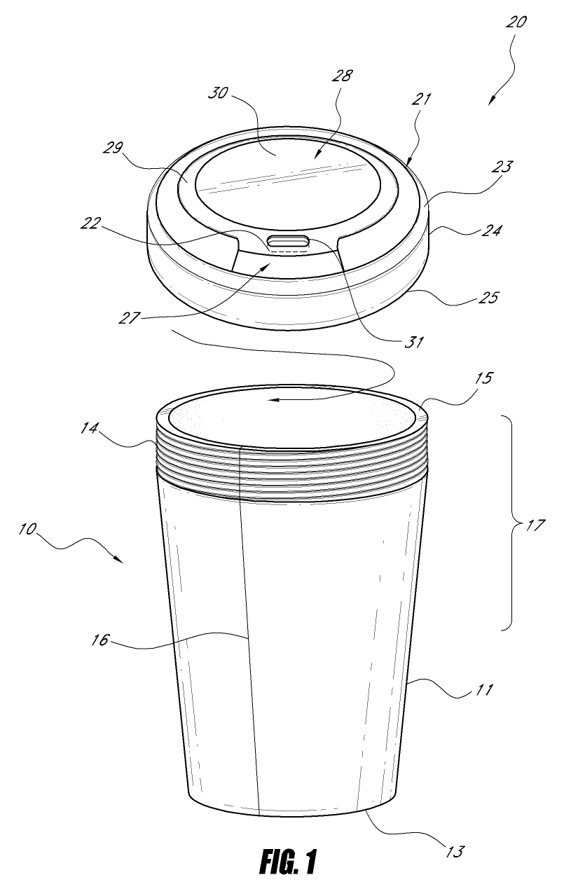

Referring to FIG. 1, the improved coupling system can preferably be a means for mating the lid 20 to the container 10 and, in some embodiments, the means can be threading 14 on the upper portion 17 of the container 10 and complementary threading on the side wall 24 of the lid 20. When the lid 20 is connected to the container 10, the cup assembly can reduce or eliminate the likelihood of the contents of the assembly from inadvertently escaping.

In some embodiments, the cup assemblies can be configured to reduce or eliminate the likelihood of liquid dripping or seeping through connections or fittings between the container 10 and lid 20. The cup assemblies can be made from disposable materials capable of holding a substance hotter than about 110 degrees Fahrenheit (e.g. about 180-185 degrees Fahrenheit) such as paper or Styrofoam, and can have threading configured to allow a lid 20 and container 10 to interlock with each other and can resist inadvertent decoupling from deformations in or to the cup assemblies. The improved coupling system for the cup assemblies can ensure that the lid 20 will not separate from the container 10 during normal use or when the cup assemblies are knocked over.

In some embodiments, the cup assemblies can have a lid with an opening configured to reduce or eliminate the likelihood of splashing or dripping from the opening in the lid. In some embodiments, the lid can rotate from an open position to a closed position. In the closed position, the cup assemblies can preferably have a leak proof, splash proof and drip proof characteristic.

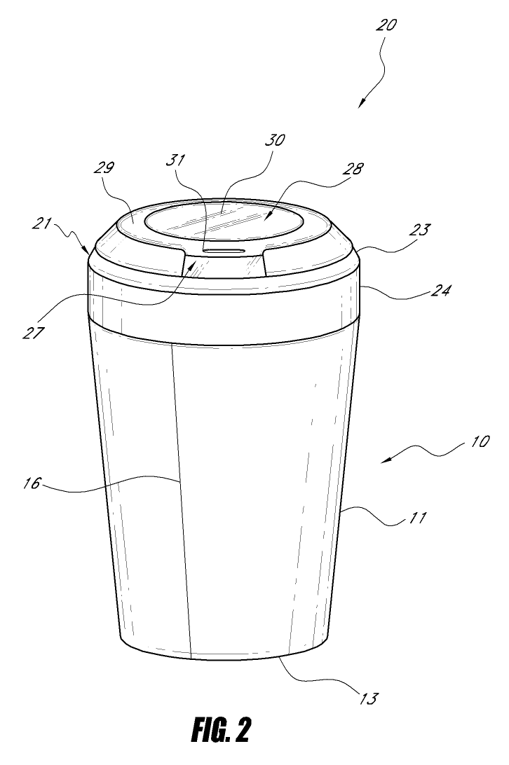

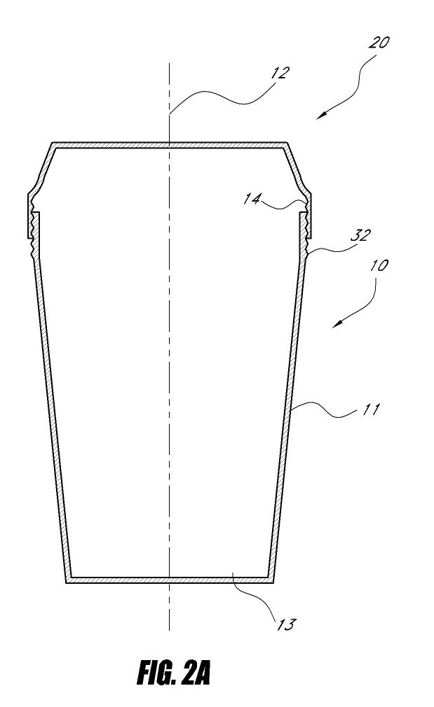

As illustrated in the embodiment of FIGS. 1 and 2, the container 10 can preferably comprise a generally tubular side member 11 that tapers from the upper end to the lower end, wherein the lower end can have a smaller diameter and circumference than the upper end. The tubular side member 11 can preferably comprise a longitudinal axis 12, as illustrated in FIG. 2A, that can extend through the center along the length of the container 10. The lower end can preferably comprise a circular bottom wall 13 that can be generally perpendicular to the longitudinal axis 12 and can substantially traverse the lower end of the tubular side member 11.

In other embodiments, the container can comprise a generally tubular side member that tapers from the lower end to the upper end, wherein the lower end can have a larger circumference and diameter than the upper end. In other embodiments, the container can comprise a generally tubular side member with substantially vertical sides, wherein the lower end can have substantially the same circumference and diameter as the upper end. In other embodiments, the container can include a lower portion and an upper portion of unequal sizes, circumferences, diameters and/or shapes. For instance, in some embodiments, the lower portion of the container can be sized and shaped to fit cup holders in automobiles.

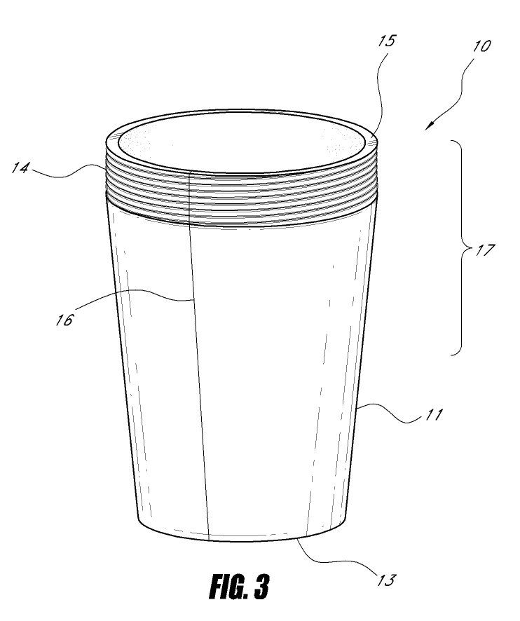

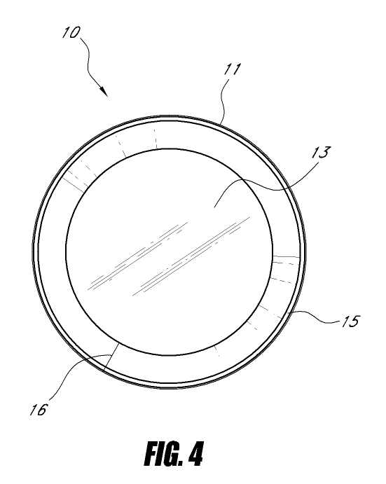

With reference to FIGS. 1, 3 and 4, the upper portion 17 of the container 10 can include threads 14 that are configured to couple with a complementary surface on a lid 20. In some embodiments, the container threads 14 can be along the upper portion of the container and can extend up to the top edge 15 of the container 10. In some embodiments, the container threads 14 can be formed and/or disposed on at least a portion of the outer surface of the container 10. In other embodiments, the threads can be formed and/or disposed on at least a portion of the inner surface of the container 10.

In some embodiments, the top edge 15 of the container can be lipless. In other words, the top edge 15 does not include a curled edge along the periphery of the container opening. Instead, the top edge 15 of the container can be generally planar and can have a surface that is substantially perpendicular to the longitudinal axis 12. The absence of a lip on the container 10 can facilitate coupling of the lid 20 to the container 10, can improve the connection between the lid and container, and can minimize leakage between the lid and container.

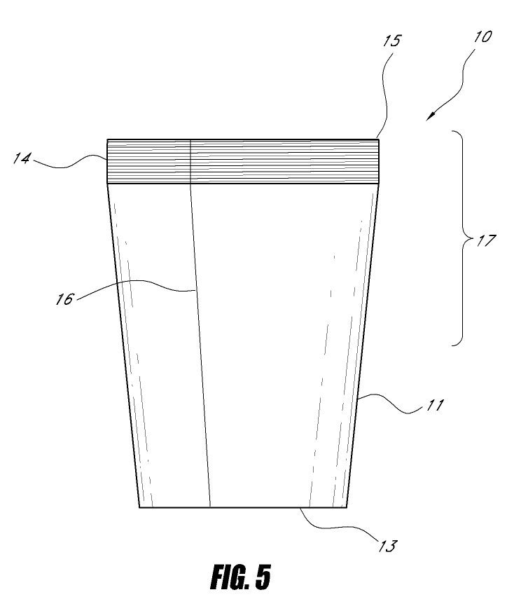

In some embodiments, the container 10 can be cut and rolled from a sheet of material. The left and right ends of the sheet can be mated to each other to create a generally cylindrical container shape. The sheet can be rolled so that one side of the sheet overlaps the other opposite side of the sheet, creating a seam 16 that can extend the length of the container 10, as shown in FIG. 5. In some embodiments, the right end of the sheet can overlap the left end of the sheet so that the lid threads 32 do not bind on the seam 16 when the lid 20 is twisted onto the container 10. The seam 16, however, can act as a stop in some embodiments. For instance, the seam can act to reduce or eliminate the likelihood of the lid inadvertently detaching from the container by restraining the threads on the lid and keeping the lid from twisting off of the container.

The container 10 can be made of a disposable material that can have insulating properties and/or can be formed to create insulating characteristics, such as Styrofoam or plastic, but preferably paper. In some embodiments, the container can be made from recyclable and/or biodegradable materials, including but not limited to paper, biodegradable plastic and corn starch, to help to minimize impacts on the environment. In some embodiments, the bottom wall 13 of the container 10 can be made of the same material as the tubular side member 11. In other embodiments, the bottom wall 13 can be made of a material having a sufficient weight to reduce or eliminate the likelihood of an empty container tipping over or blowing away. In other embodiments, the bottom wall can be made of or otherwise incorporate a material such as metal (e.g., aluminum, tin, steel, etc.) to provide a heat transfer surface for keeping the contents of the container warm when the container is placed on a heating element.

With continued reference to FIGS. 1 and 2, the lid 20 can preferably be adapted to span the opening in the upper portion 17 of the container 10. The opening can be generally defined by the upper rim or top edge 15 of the container 10. In some embodiments, the lid 20 can comprise two pieces that are connected together, but are free to rotate with respect to one another. In this embodiment, the lid 20 can generally have a first piece 21 that can couple with the container 10, and a movable second piece 28. In some embodiments, the lid 20 can comprise one piece that spans the opening in the upper portion 17 of the container 10. The overall shape of the lid 20 can be generally frustaconical; however, the lid 20 can have a number of other configurations.

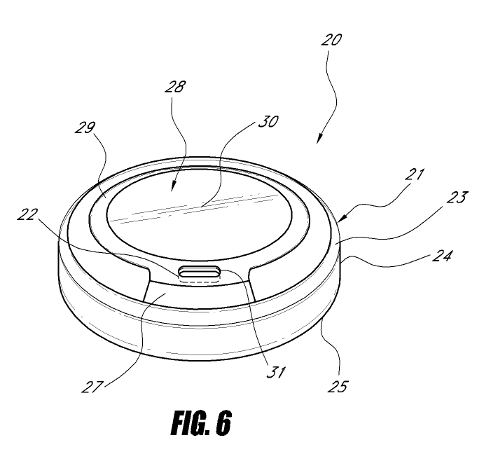

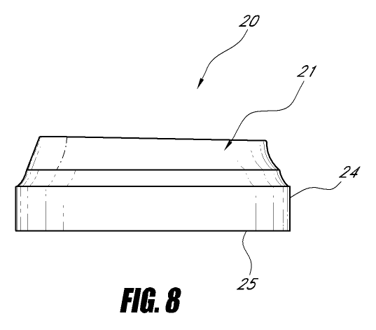

As illustrated in FIGS. 6, 7 and 8, the first piece 21 can have a top wall 23 and a side wall 24 extending from a peripheral edge of the top wall 23 in a generally perpendicular direction. Although the top wall 23 can have a generally flat surface, the embodiment illustrated in the figures has a top wall 23 that is curved or angled. In some embodiments, the side wall 24 can have a generally cylindrical shape and can have a lower edge 25.

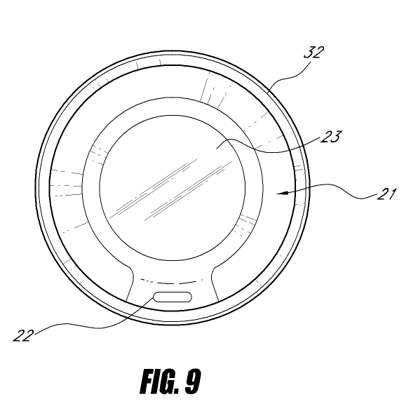

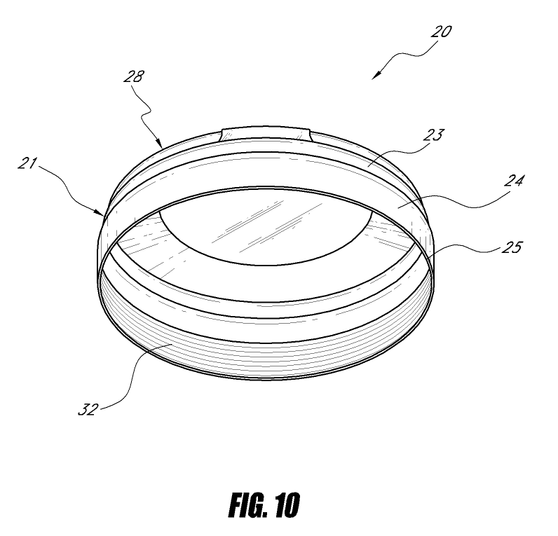

The lower portion of the lid side wall 24 can include threading 32, as illustrated in FIGS. 9 and 10, which can be configured to couple with the container threads 14 on the upper portion 17 of the container 10. In some embodiments, the lid threads 32 can be disposed on the inner surface of the side wall 24 and can be configured to couple with complementary container threads 14 on the outer surface of the container 10. In other embodiments, the lid threads 32 can be disposed on the outer surface of the side wall 24 and configured to couple with complementary container threads 14 on the inner surface of the container 10. The side wall 24 can preferably be adapted for coupling the lid 20 to the container 10 in a manner that seals or substantially seals the lid 20 onto the container 10. The threaded side wall 24 can be configured to reduce or eliminate the likelihood of the container contents leaking through the connection or fitting between the lid 20 and the container 10.

The top wall 23 of the first piece 21 can preferably have a drink opening 22, as illustrated in FIG. 6. Alternatively, the drink opening 22 can be at least partially located in the side wall 24. The drink opening 22 can preferably be adapted to permit the passage or flow of the contents in the container 10 through the first piece 21. The drink opening 22 can have a variety of shapes, including but not limited to a circular, square, or rectangular shape.

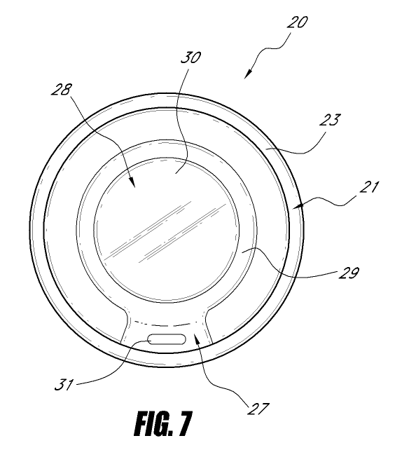

With reference to FIGS. 6 and 7, the second piece 28 can comprise a top wall 29 and a center portion 30 that can extend radially inward from the top wall 29. Alternatively, the center portion 30 can be removed to reduce the weight and/or cost of the second piece 28. In this configuration, the second piece 28 can have an annular-shaped configuration.

The second piece 28 can have at least one aperture 31. When the aperture 31 is aligned with the drink opening 22, a passageway can be formed permitting the passage or flow of the substance in the container 10 through the lid 20. Although the aperture 31 can have a variety of configurations and dimensions, the aperture 31 can preferably have a similar dimension as the drink opening 22.

The second piece 28 and the first piece 21 can be cooperatively configured such that the second piece 28 can be rotatably coupled with the first piece 21 to define an assembled position. In the assembled position, the second piece 28 can be movable between a first position and a second position. In the first position, the lid 20 can be in a closed configuration where the drink opening 22 is not aligned with the aperture 31 and the drink opening 22 is obstructed by the second piece 28. In the second position, the lid 20 can be in an open configuration where the aperture 31 can be at least partially aligned with the drink opening 22 and a passageway is formed through the second piece 28 and the first piece 21. In some configurations, the aperture 31 and the drink opening 22 can be entirely aligned, and neither the drink opening 22 nor aperture 31 is obstructed. The passageway permits the passage or flow of the substance in the container 10 through the lid 20.

In some embodiments, the first piece 21 can have more than one drink opening, wherein the drink openings can be positioned at discrete positions along the first piece 21. In this configuration, the second piece 28 can be rotated in either a clockwise or counter-clockwise direction to align the aperture 31 with any one of the several drink openings.

In some embodiments, a biasing member can be provided that biases the second piece 28 in a first position wherein the aperture 31 in the second piece 28 is not aligned with the drink opening 22 in the first piece 21. When the cup is not in use, the biasing member can exert a force on the second piece 28 that biases the second piece 28 into a closed configuration. After each sip, the biasing member can return the second piece 28 to the closed configuration to reduce or eliminate the likelihood of any inadvertent spills or splashes. In some embodiments, the biasing member can be a spring member. In some embodiments, the biasing member can be a resilient member.

The first piece 21 and/or second piece 28 can comprise a drinking portion 27, as illustrated in FIGS. 6 and 7, adapted to receive a user's lip when the user is drinking from the cup. The drinking portion 27 can be a projection or a recess in the first piece 21 and/or second piece 28. In some embodiments, the drinking portion 27 can be a projection that is contoured to provide for comfortable and controlled drinking. In some embodiments, the projection generally can have a spout shape. In other embodiments, the drinking portion 27 can have a recessed portion with a depression inward from the side wall 24 surface. In some embodiments, the recessed portion can be positioned on both the second piece top wall 29 and the side wall 24. In other embodiments, the recessed portion can be limited to either the second piece top wall 29 or the side wall 24. The depth of recess of the recessed portion can vary. The shape and configuration of the recessed portion can be varied to conform to different sizes and shapes of user lips. In some embodiments, the drinking portion 27 can be disposed surrounding the aperture 31.

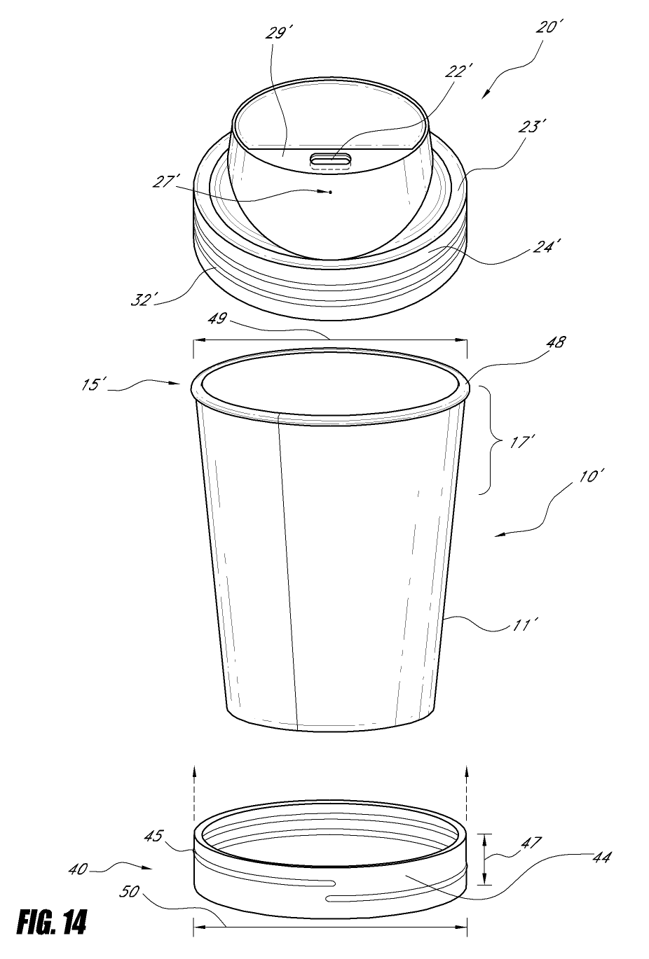

As mentioned above, the lid can be a one piece lid. Features of the first piece 21 and second piece 28 (described above) can be included on the one piece lid. For example, similar to the embodiments of the lid 20 comprising two pieces, the lid 20′ can comprise a drink opening 22′ disposed on the upper top wall 29′ of the lid, as illustrated in the embodiment of the lid in FIG. 14. The lid 20′ can comprise a drinking portion 27′ adapted to receive a user's lips, as described for the two piece lids. Further, the lid 20′ can comprise a lower top wall 23′ and a side wall 24′ that extends therefrom. Threads 32′ can be disposed on the inner side of the side wall 24′. In some embodiments, the lid 20′ shown in FIG. 14 can also comprise of two or more pieces that allow for rotation between the respective pieces.

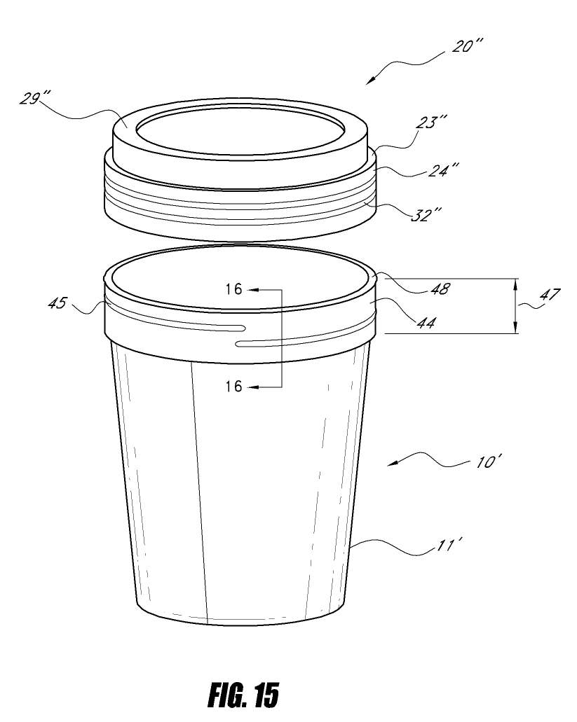

In some embodiments, the lid may not have a drink opening. Similar to other embodiments of lids discussed above, the closed lid 20″ (shown in FIG. 15) can comprise an upper top wall 29″ and a lower top wall 23″. The closed lid 20″ can also comprise a side wall 24″ extending from the lower top wall 23″ and threads 32″ on the inner side of the side wall 24″. Embodiments of the closed lid 20″ can advantageously contain the liquid and/or heat within the container 10, without a significant risk of the liquid or heat escaping through a drink opening. The closed lid 20″ can be removed from the container 10 when the user is ready to consume the beverage.

The shape of the side wall 24 can be substantially circular and generally match the shape of the top edge 15 of the container 10, as illustrated in FIG. 1, to form a cooperative sealing engagement when the lid and container are connected together, as illustrated in FIG. 2. Although the lid 20 is shown as having a generally circular shape, the lid can have numerous configurations, such as, for example, rectangular, square, or oval shape. Regardless of the shape of the lid 20, the side wall 24 of the lid can be sized and shaped to mate with a container 10 having threading along the upper portion 17 of the container 10.

The threads on the container 14 can preferably be configured to couple with the lid threads 32. Therefore, the orientation, size, and pitch of the container threads 14 can be complementary to the lid threads 32. In some embodiments, where the container threads 14 are on the outer surface of the container 10, the lid threads 32 can be disposed on the inner surface of the side wall 24. In some embodiments, where the container threads 14 are on the inner surface of the container 10, the lid threads 32 can be disposed on the outer surface of the side wall 24.

The pitch of the threads 14, 32 can preferably be configured to provide a seal between the container 10 and lid 20 that reduces or eliminates the likelihood of liquids seeping between the mating surfaces of the threads. The pitch is defined as the number of threads per inch.

The container 10 can be constructed using several different manufacturing methods, depending on the material, structure and features of the container 10. For paper containers, a sheet of paper stock can be cut and rolled into the shape of a container. The edges of the rolled paper stock can be adhered to one another through adhesive bonding, or other bonding method, creating the seam 16 along the length of the container 10. Another component can be attached to the bottom opening to form the bottom wall 13 of the container 10. In some embodiments, the paper stock can have ridges, dimples, or other features (not shown) to provide insulation to protect the consumer's hand from excessive heat or cold from the contents of the container.

In some embodiments, the threads 14 can be molded or formed into the container 10. For instance, the threads can be embossed and/or debossed on the container. In some embodiments a wire, molded plastic component, or other reinforcement can be used with the paper stock to provide a rigid support for the threads on the container 14. In some embodiments, the reinforcement can be inserted between two layers of paper stock. For example, a preformed helical wire can be embedded in-between the two layers of paper stock, which can provide a rigid support frame for the threads and can be molded on the outer surface of the paper stock. With the added support of the reinforcement member, the container threads 14 can be more resilient to structural deformations and facilitate a more leak resistant seal between the container 10 and lid 20.

In some embodiments, the paper stock can have threads that are preformed along its entire length. The sheet of paper stock with the preformed threads can be cut and rolled into the shape of a container 10 so that the threads run along the entire length of the cup from the top edge 15 to the bottom wall 13. In some embodiments, only a portion of the threads on these embodiments of containers can be used to couple with the lid 20. However, in some embodiments, the thread features along the length of the container can also help to provide insulation for protecting the consumer's hand. This method of thread construction can advantageously reduce manufacturing costs by eliminating the need to form threads on a specific portion of the container 10.

Another material that can be employed in constructing the container 10 is plastic. Plastic containers can be molded or thermoformed using vacuum or pressure forming. The container threads 14 can be formed during the same molding or thermoforming process as the container 10. In some embodiments, the container threads 14 can be integrally formed as a part of the container 10. In other embodiments, the container threads 14 can be formed as a separate component that can be coupled with the container 10 in a separate manufacturing process.

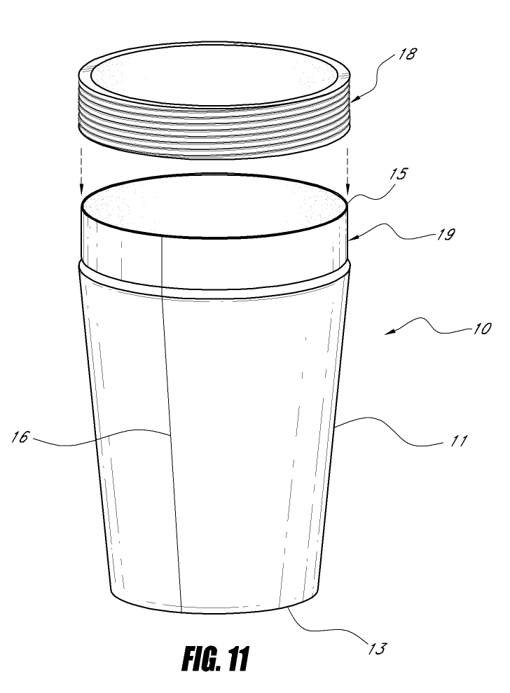

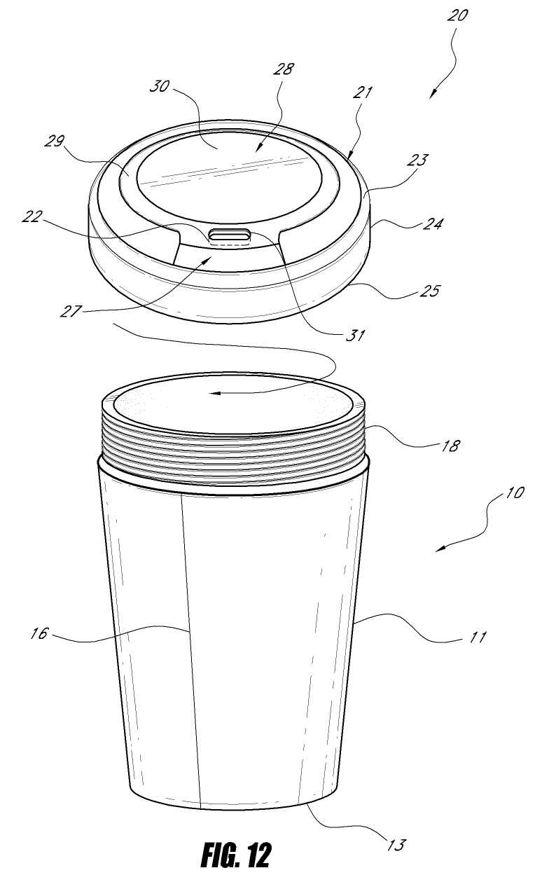

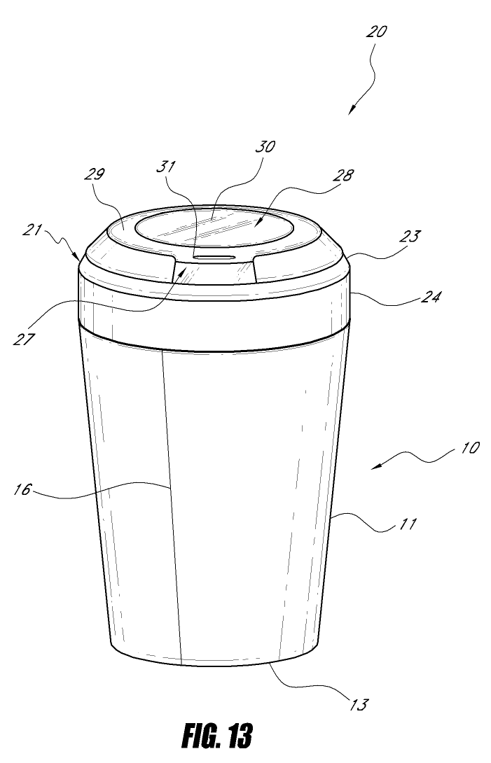

As illustrated in FIGS. 11-13, in alternative embodiments a separate threaded component or fitting 18 can comprise of a different material from the container 10, one which can preferably be more rigid than the container material and can include a different type of paper stock from the container. For example, the threaded component or fitting 18 can be made of plastic to attach to a paper container 10. In another embodiment, container 10 can be made of a plastic and the threaded component can be made of a stiffer plastic than the container plastic. In some embodiments, the threaded component or fitting 18 can comprise of other strong and rigid material, including but not limited to metals and fiberglass. The container threads 14 on the threaded component or fitting 18 can be complementary to the lid threads 32. The rigid material can be capable of resisting deformation and generally maintains its structural form during use of the container 10, which facilitates a tighter seal with the lid 20.

In some embodiments, the container 10 can comprise a recessed portion 19 on the upper portion 17 for accepting the threaded component or fitting 18, as illustrated in FIG. 11. The recessed portion 19 can be a portion of the container 10 with a wall having a smaller thickness compared to other portions of the container 10. The recessed portion 19 can extend to the top edge 15 and can have a length substantially the same as the length of the threaded component or fitting 18. In some embodiments, the recessed portion 19 can have structures, such as ridges or stops, to keep the threaded component or fitting 18 from sliding relative to the container 10 when a lid 20 is connected to the container and a rotational torque is applied to tighten the lid 20 to the container.

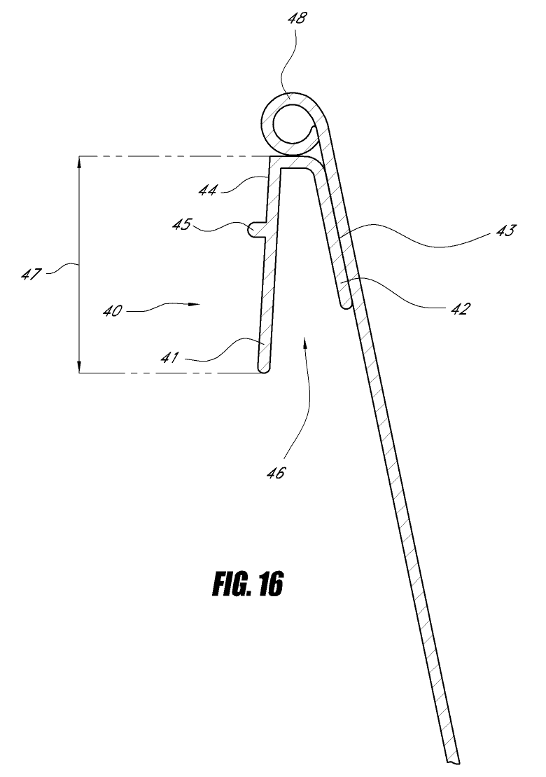

In other embodiments illustrated in FIGS. 14-16, a threaded ring component 40 can be configured to couple with an upper portion 17′ of a container 10′. As illustrated in FIG. 16, the ring component can comprise a first portion 41 with an inner surface 43 and a second portion 42 with an outer surface 44. In the illustrated embodiment, the inner surface 43 can be angled to abut against the tubular side member 11′ of the container 10′. Preferably, the inner surface 43 can lay flat against the tubular side member 11′. In some embodiments, the inner surface 43 can have cutouts or a rough surface that can promote adhesion by glue or other bonding chemicals. In some embodiments, the inner surface 43 may not be angled and may not lie flat against the tubular side member 11′. In some embodiments, the ring component 40 can be attached to the tubular side member with an adhesive or other suitable bonding agent that fills any gaps between the ring component 40 and the tubular side member 11′.

The outer surface 44 of the ring component 40 can comprise threads 45 that are complimentary to the threads 32 on the lid 20. Preferably, the outer surface 44 can be substantially vertical and can couple with the side wall 24 of the lid 20, which can also preferably be substantially vertical. In the embodiment of the ring component 40 illustrated in FIGS. 14-16, a channel 46 can be disposed between the first portion 41 and the second portion 42. In some embodiments, the first portion 41 and the second portion 42 can be connected on both ends, such that the cross sections of the first portion 41 and the second portion 42 can encompass and define a cavity. In some embodiments, the ring component 40 can have no channel 46. In some embodiments, the ring component 40 can be formed by casting or molding.

The width 47 of the ring component 40 can preferably be wide enough for at least one winding of the thread. In some embodiments, the width 47 of the ring component 40 can be generally the same as the width of the side wall 24 of the lid 20, such that the side wall 24 overlaps the entire width 47 of the ring component 40 when the lid 20 is coupled to the container 10′. In some embodiments, the width 47 of the ring component 40 can be approximately ⅜ of an inch and can comprise approximately one winding of a thread 45 having a pitch of approximately 3/16 of an inch.

In the illustrated embodiment of FIGS. 14-16, the container 10′ can comprise a lip 48 on the top edge 15′. In some embodiments, the lip can be formed by curling the top edge 15′ of the container 10′ around the periphery of the container opening, as illustrated in FIG. 16. In some embodiments, the outer diameter 49 of the lip 48 can be substantially the same as the outer diameter 50 of the ring component 40 such that the outer edge of the lip 48 is generally aligned with the outer surface 44 of the ring component 40, which can assist in forming a leak resistant seal between the lid 20 and the container 10′. In other embodiments, as discussed above, the container can be lipless.

In some embodiments, when a lid such as lid 20, 20′, 20″ is screwed onto the container 10′, the lip 48 can mate with the top wall 23 of the lid to form a leak resistant seal. The seal can be formed when the threaded connection moves the container 10′ and the lid toward each other to create a compressive force between the lip 48 and the top wall 23. In some embodiments, the lip 48 can deform against the top wall 23 to create a tight leak-resistant seal. In other embodiments, the top wall 23 may deform, or both the top wall 23 and the lip 48 may deform.

The ring component 40 can comprise of a different material than the container 10′, one which can preferably be more rigid than the container material. In some embodiments, the ring component 40 can be sufficiently pliable and soft so that a consumer can comfortably drink from the container without a lid. In some embodiments, the ring component 40 can be made of the same material as the lid. In some embodiments, the ring component 40 can be made of materials different from the lid. Examples of materials for the ring component include, but are not limited to, metal, plastic, rigid paperstock and fiberglass. In some embodiments, the rigid material can be capable of resisting deformation and can generally maintain its structural form during use to facilitate a tight seal between the ring component 40 and the lid 20.

The ring component 40 can be coupled to the container 10′. In some embodiments, the inner surface 43 of the ring component 40 can be adhered to the side wall 11′ at the upper portion 17′ of the container 10′, as illustrated in FIG. 16. Some examples of adhesives can include hot glue or bonding chemicals. In preferred embodiments, the ring component 40 can be permanently attached to the container 10′, and in the case of disposable containers, the ring component 40 can be discarded along with the disposable container. In other embodiments, the ring component 40 can be removed from the container and discarded or reused. In some embodiments, the ring component 40 can be part of the container 10′ so that the container 10′ and ring component 40 are integral.

In a method of manufacturing, the separate threaded component or fitting 18 can be molded separately from the container 10 and then affixed to the container 10. The threaded component or fitting 18 can be coupled to the container 10 in some embodiments, or to the recessed portion 19 of the container 10 in other embodiments. For instance, the threaded component or fitting 18 can be heated to a viscous state and allowed to fuse with the recessed portion 19 as it cools to a solid state. Other methods of binding the threaded component or fitting 18 with the container 10 can include chemical adhesion. In some embodiments, the threaded component or fitting 18 can be held in place on the container 10 through friction. In preferred embodiments, the threaded component or fitting 18 can extend from the top edge 15 of the container 10 to approximately a half inch to one inch along the side of the container 10. In other embodiments, the threaded component or fitting 18 can extend from the top edge 15 of the container 10 to generally the bottom of the container 10 to extend along a majority of the length of the side of the container. In some embodiments, the threaded component or fitting 18 can have threads formed on only a portion of the length of the threaded component or fitting 18. In some embodiments, the threaded component or fitting 18 can be coupled to the container 10 by inserting the bottom of the container 10 through an opening of the threaded component or fitting 18.

In some embodiments, the first piece 21 and second piece 28 components of the lid 20 can be made from plastic. The first piece 21 and second piece 28 can be formed by injection molding or a thermoforming operation, such as vacuum forming and/or pressure forming. However, other lightweight materials can be used to form the lid 20 including paper or the same material used to make the container. In preferred embodiments, the second piece 28 can be formed from the same material used to form the first piece 21. After the manufacturing process has been completed, the drink opening 22 can be formed in the first piece 21, in some embodiments, with a punch and die. Similarly the aperture 31 in the second piece 28 can be formed with a punch and die after the second piece 28 is formed. The first piece 21 and second piece 28 can be coupled together to construct a lid with a closable opening.

The threads on the side wall 24 of the lid 20 can be formed in the same operation as the first piece 21 construction. In some embodiments, the threads can be integrated into the first piece 21 so that the first piece 21 and threads are formed as a single piece. In other embodiments, the side wall 24 can be formed separately and affixed to the first piece 21.

In a method of using an embodiment of the disposable drinking cup, a lid 20 can preferably be attached onto a container 10 after a consumer fills the container with a desired substance such as a liquid or a hot beverage. The lid 20 can preferably be aligned with the container 10 so that the bottom of the lid 20 is facing the top edge 15 of the container 10. The two components can be connected by engaging the threads 32 on the lid 20 with the threads 14 on the container 10, and then twisting the lid onto the container. The lid 20 can be rotated clockwise, or counter-clockwise depending on the orientation of the threads, in order to fasten the lid to the container 10. In preferred embodiments, the mating surface between the lid 20 and container 10 can be sufficiently tight so that the contents of the container (e.g., liquid) is unlikely to seep between the lid and container. In some embodiments, the lid can be fastened to the container after less than a full 360 degree turn of the lid onto the container. For instance, the lid can be fastened to the container by twisting the lid approximately 180 degrees onto the container.

In some embodiments, the lid 20 can have two pieces, a first piece 21 and a second piece 28, that freely rotate with respect to each other from a closed configuration to an opening configuration. The lid 20 can preferably be secured to the container 10 in a closed configuration where the aperture 31 in the second piece 28 of the lid 20 is not aligned with the drink opening 22 in the first piece 21 portion of the lid 20. In the closed configuration, no part of the aperture 31 in the second piece 28 may overlap any part of the drink opening 22 in the first piece 21 portion, thereby preventing or substantially preventing the contents of the cup assembly from escaping through the holes.

To consume the contents of the container, the consumer can rotate the second piece 28 in relation to the first piece 21 to an open configuration where the aperture 31 in the second piece 28 is aligned with the drink opening 22 in the first piece 21. In the open configuration, a passageway is created for liquid to pass through. In a fully opened position, the aperture 31 can be positioned so that the entire perimeter of the drink opening 22 and/or aperture 31 acts as a passageway. In a partially opened position, at least a portion of the aperture 31 can be aligned with at least a portion of the drink opening 22, so that a passage is created that is smaller than the size of either hole.

When the consumer is not drinking from the cup, the consumer can rotate the second piece 28 of the lid 20 so that the aperture 31 is not aligned with the drink opening 22 and can prevent the contents from accidentally spilling from the cup assembly. In some embodiments, a mechanism can be provided that biases the second piece 28 in a position wherein the aperture 31 is not aligned with the drink opening 22, so that when not in use, the lid 20 can automatically return to the closed configuration.

In some embodiments, the lid 20 can be detached from the container 10, if necessary, and reattached, with minimal effect to the container 10 and lid 20 components. In some embodiments, the attaching and detaching of the lid 20 from the container 10 may not significantly affect the structural integrity of the threads on either the container 10 or the lid 20.

In some embodiments, the container and the lid can be configured to provide an interference fit when the lid 20 is coupled to the container 10, thus creating a leak resistant seal. In other embodiments, the container 10 or lid 20 can be provided with a deformable surface that can couple with threads on the other component to form the interference fit. In some embodiments, at least a portion of the container 10 and/or lid 20 can be made of a deformable, but resilient material, such as, for example rubber, so that the container 10 and/or lid 20 can return to its original shape when the container 10 and lid 20 are decoupled. In other embodiments, at least a portion of the container 10 and/or lid 20 can remain in a deformed configuration after the lid 20 is initially coupled to the container 10.

Although certain embodiments, features, and examples have been described herein, it will be understood by those skilled in the art that many aspects of the methods and devices illustrated and described in the present disclosure may be differently combined and/or modified to form still further embodiments. For example, any one component of the disposable cup assembly illustrated and described above can be used alone or with other components without departing from the spirit of the present invention. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by the claims that follow.

What is claimed is:

1. A disposable cup assembly comprising:
a container made from a paper material, the container having a bottom and at least one side wall, wherein the at least one side wall has an upper portion and a lower portion, the upper portion defining an opening in the container for receiving a substance; and
a lid adapted to cover the opening of the container, wherein the lid has a top and at least one flange that extends from the top and is adapted to engage with the upper portion of the container;
wherein at least a section of the upper portion of the container has threading to receive and engage with the at least one flange of the lid.

2. The cup assembly of claim 1, wherein the container has a seam along a length of the at least one side wall and wherein the threading crosses the seam and is a continuous helical ridge along the upper portion of the at least one side wall.

3. A disposable cup assembly comprising:
a lipless container made from a biodegradable material capable of holding a substance hotter than 120 degrees Fahrenheit, the container having a bottom and at least one side wall, wherein the at least one side wall has an upper portion and a lower portion, the upper portion defining an opening in the container for receiving the substance; and
a lid adapted to cover the opening of the lipless container, wherein the lid has a top and at least one flange that extends from the top and is adapted to engage with the upper portion of the container;
wherein at least a section of the upper portion of the lipless container has threading to receive and engage with the at least one flange of the lid.

4. The assembly of claim 3, wherein the lid has threading along the at least one flange that is complementary to the threading of the container and is configured to allow the lid to engage with the container by twisting the lid onto the container.

5. The assembly of claim 4, wherein the at least one side wall of the container is made of paper and the at least one side wall has an interior surface and an exterior surface.

6. The assembly of claim 5, wherein the threading of the container is formed on the exterior surface of the at least one side wall.

7. The assembly of claim 4, wherein the top of the lid has an opening configured to dispense the substance from the container when the lid is engaged with the container.

8. The assembly of claim 4, wherein the lid is made of the same material as the container.

9. The assembly of claim 8, wherein the container is made of paper.

10. The assembly of claim 3, wherein the threading along the at least one side wall is molded on the container.

11. The assembly of claim 3, wherein the threading along the at least one side wall is on a connector that is affixed to the upper portion of the container.

12. The assembly of claim 11, wherein the connector is made of a material that is different from the container.

13. The assembly of claim 12, wherein the connector is made of plastic.

14. A method of manufacturing a cup assembly having a coupling system, comprising:
determining a length and width for a container of the cup assembly;
selecting a biodegradable material for the container suitable for holding a substance hotter than 120 degrees Fahrenheit;
measuring and cutting a sheet of the material for the container;
rolling the sheet of the material to form a side wall of the container; and
applying threads along at least a portion of the side wall.

15. The method of manufacturing a cup assembly of claim 14, wherein the biodegradable material is paper.

16. The method of manufacturing a cup assembly of claim 15, wherein the threads are applied to the side wall by molding the threads onto the paper.

17. The method of manufacturing a cup assembly of claim 15, wherein the threads are on a connector sized to fit an upper portion of the side wall and are applied to the side wall by affixing the connector to the upper portion.

18. The method of manufacturing a cup assembly of claim 17, wherein the connector is made of a plastic material.

19. The method of manufacturing a cup assembly of claim 18, wherein the connector is affixed to the upper portion by using a chemical adhesive between an inner surface of the connector and an outer surface of the upper portion.
